(19) United States
(12) Patent Application Publication
(10) Pub. No.: US 2024/0026053 A1
(43) Pub. Date: Jan. 25, 2024

(54) TRANSPARENT ARTICLE

(71) Applicant: Polyplastics Co., Ltd., Tokyo (JP)

(72) Inventors: Tomoyuki Tada, Fuji-shi (JP); Naoyuki Wakitani, Fuji-shi (JP); Atsushi Nakano, Fuji-shi (JP)

(73) Assignee: Polyplastics Co., Ltd., Tokyo (JP)

(21) Appl. No.: 18/029,786

(22) PCT Filed: Sep. 3, 2021
(86) PCT No.: PCT/JP2021/032389

§ 371 Date: Mar. 31, 2023

(30) Foreign Application Priority Data
Oct. 2, 2020 (JP) 2020-167778

(51) Int. Cl. C08F 232/08; C08F 210/02; C08K 5/12; G02B 1/04

(52) U.S. Cl. CPC C08F 232/08; G02B 1/04; C08K 5/12; C08F 210/02

(57) ABSTRACT

A transparent article is obtained by molding a cyclic olefin copolymer or a resin composition containing the cyclic olefin copolymer. The cyclic olefin copolymer is obtained by a process that at least includes a step of preparing a norbornene monomer and ethylene as monomers in a polymerization vessel and a step of polymerizing the monomers in the polymerization vessel in the presence of a metal-containing catalyst. The metal-containing catalyst satisfies predetermined conditions.

### TECHNICAL FIELD

The present invention relates to a transparent article, more specifically, to a transparent article obtained by molding a cyclic olefin copolymer or a resin composition containing the cyclic olefin copolymer.

### BACKGROUND ART

A cyclic olefin homopolymer and a cyclic olefin copolymer have low hygroscopicity and high transparency, and are applied to various purposes, for example, in a field relating to an optical material such as an optical disk substrate, an optical film, and an optical fiber. A copolymer of cyclic olefin and ethylene, which is a representative cyclic olefin copolymer, has been widely used as a transparent resin. The copolymer of cyclic olefin and ethylene has a glass transition temperature that can be changed in accordance with a copolymer composition of cycling olefin and ethylene, and hence it is possible to manufacture a copolymer having a glass transition temperature (Tg) adjusted within a wide temperature range (see Non-Patent Literature 1, for example).

### CITATION LIST

### Non-Patent Literature

[Non-Patent Literature 1] Incoronata, Tritto et al. 2006. Coordination Chemistry Reviews. Vol. 250, pp. 212 to 241

### SUMMARY OF INVENTION

### Technical Problem

However, the method described in Non-Patent Literature 1 causes a problem that the copolymer of cyclic olefin and ethylene cannot be manufactured in a high yield. As a countermeasure for this problem, it is considered that polymerization is performed through use of a highly active catalyst. Yet, when a highly active catalyst is used for polymerization, polyethylene-like impurities are easily generated in some cases. In a case in which a cyclic olefin copolymer contains polyethylene-like impurities, when the cyclic olefin copolymer is dissolved in a solvent, turbidity is caused. Thus, there is a risk of degradation of transparency of the cyclic olefin copolymer. It is difficult to apply such a cyclic olefin copolymer to an article that requires transparency.

The present invention has been made in view of the above-mentioned problem in the related art, and has an object to provide a transparent article that is obtained by molding a cyclic olefin copolymer obtained by polymerizing cyclic olefin and ethylene or a resin composition containing the cyclic olefin copolymer, the transparent article having less polyethylene-like impurities and being excellent in transparency.

### Solution to Problem

In order to solve the above mentioned problem, an aspect of the present invention is as below.

(1) A transparent article obtained by molding a cyclic olefin copolymer containing a constituent unit derived from a norbornene monomer and a constituent unit derived from ethylene or a resin composition containing the cyclic olefin copolymer, wherein
the cyclic olefin copolymer is obtained by a process that at least includes a step of preparing a norbornene monomer and ethylene as monomers in a polymerization vessel and a step of polymerizing the monomers in the polymerization vessel in the presence of a metal-containing catalyst and satisfies Condition A and Condition B given below.

Condition A: a pressure for preparing ethylene in the polymerization vessel is 0.5 MPa or higher, and the metal-containing catalyst has a ligand including a cyclopentadiene ring and a structure in which a hetero atom being N, O, S, or P are bonded to transition metal of the fourth group in the periodic table and sp² carbon.

Condition B: the metal-containing catalyst has a structure in which a nitrogen atom is bonded to transition metal of the fourth group in the periodic table and an atom of the fifteenth group in the periodic table.

(2) The transparent article according to the item (1), wherein the atom of the fifteenth group in the periodic table is a phosphorus atom.

(3) The transparent article according to claim 1 or 2, wherein
the metal-containing catalyst is a metal-containing compound expressed in Formular (a1) given below:

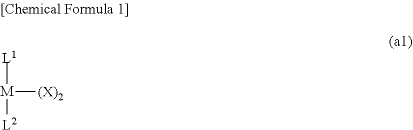

where, in Formula (a1), M is Ti, Zr, or Hf, X is an organic substituent group having 1 to 20 carbon atoms and optionally containing a hetero atom, or a halogen atom, and L¹ is a group expressed in Formula (a1a) or Formula (a1b) given below;

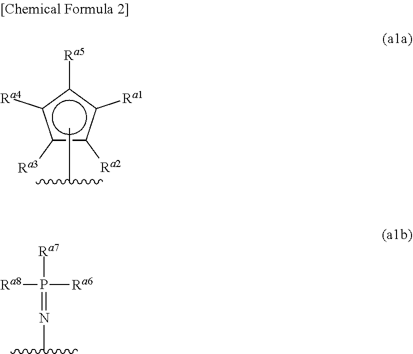

where, when L¹ is a group expressed in Formula (a1a) given above, L² is a group expressed in Formula (a1b), Formula (a1c), or Formula (a1d) given below;

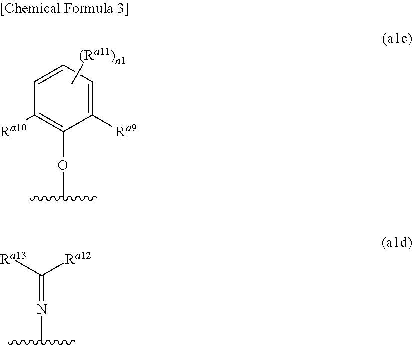

where, when L¹ is a group expressed in Formula (a1b) given above, L² is a group expressed in Formula (a1b) given above;
where, in Formula (a1a), R^{a1} to R^{a5} are each independently identical or different optionally, and are each independently a hydrogen atom, an organic substituent group having 1 to 20 carbon atoms and optionally containing a hetero atom, or an inorganic substituent group, and two groups among R^{a1} to R^{a5} that are adjacent to each other on a five-membered ring are mutually bonded and form a ring optionally;
where, in Formula (a1b), R^{a6} to R^{a8} are each independently identical or different optionally, and are each independently a hydrogen atom, an organic substituent group having 1 to 20 carbon atoms and optionally containing a hetero atom, or an inorganic substituent group, and two groups selected from R^{a6} to R^{a8} are mutually bonded and form a ring optionally;
where, in Formula (alc), R^{a9} to R^{a11} are each independently identical or different optionally, and are each independently a hydrogen atom, an organic substituent group having 1 to 20 carbon atoms and optionally containing a hetero atom, or an inorganic substituent group, and n1 is an integer from 0 to 3; and
where, in Formula (a1d), R^{a12} and R^{a13} are each independently identical or different optionally, and are each independently a hydrogen atom, an organic substituent group having 1 to 20 carbon atoms and optionally containing a hetero atom, or an inorganic substituent group, and the two groups including R^{a12} and R^{a13} are mutually bonded and form a ring optionally.

(4) The transparent article according to any one of the items (1) to (3), wherein the transition metal of the fourth group in the periodic table is Ti.

(5) The transparent article according to any one of the items (1) to (4), wherein the monomers in the polymerization vessel are polymerized at a temperature of 85° C.or higher.

(6) The transparent article according to any one of the items (1) to (5), wherein the cyclic olefin copolymer has a glass transition temperature of 185° C. or lower.

(7) The transparent article according to any one of the items (1) to (6), wherein a DSC curve does not have a peak of a melting point derived from polyethylene-like impurities within a range from 100° C.to 140° C., the DSC curve being obtained by measuring a sample of the cyclic olefin copolymer by a differential scanning calorimeter under a nitrogen atmosphere and at a temperature rising rate of 20° C./min in accordance with the method described in JIS K7121.

(8) The transparent article according to any one of the items (1) to (7), wherein the monomers are polymerized in the presence of the metal-containing catalyst and a co-catalyst.

(9) The transparent article according to the item (8), wherein the co-catalyst contains at least one of aluminoxane or a borate compound.

(10) The transparent article according to any one of the items (1) to (9), wherein the monomers are polymerized in the presence of a hydrocarbon solvent.

(11) The transparent article according to any one of the items (1) to (10), wherein the transparent article is obtained by further adding an antioxidant to the cyclic olefin copolymer or the resin composition.

### Advantageous Effects of Invention

According to the present invention, it is possible to provide the transparent article that is obtained by molding the cyclic olefin copolymer obtained by polymerizing cyclic olefin and ethylene or the resin composition containing the cyclic olefin copolymer, the transparent article having less polyethylene-like impurities and being excellent in transparency.

### DESCRIPTION OF EMBODIMENTS

A transparent article according to the present embodiment is obtained by molding a cyclic olefin copolymer containing a constituent unit derived from a norbornene monomer and a constituent unit derived from ethylene or a resin composition containing the cyclic olefin copolymer. Further, the cyclic olefin copolymer is obtained by a process that at least includes a step of preparing a norbornene monomer and ethylene as monomers in a polymerization vessel and a step of polymerizing the monomers in the polymerization vessel in the presence of a metal-containing catalyst and satisfies Condition A and Condition B given below.

Condition A: a pressure for preparing ethylene in the polymerization vessel is 0.5 MPa or higher, and the metal-containing catalyst has a ligand including a cyclopentadiene ring and a structure in which a hetero atom being N, O, S, or P are bonded to transition metal of the fourth group in the periodic table and sp² carbon.

Condition B: the metal-containing catalyst has a structure in which a nitrogen atom is bonded to transition metal of the fourth group in the periodic table and an atom of the fifteenth group in the periodic table.

In the following description, the step of preparing the norbornene monomer and ethylene as monomers in the polymerization vessel is also referred to as a preparation step. Further, the step of polymerizing the monomers in the polymerization vessel in the presence of the metal-containing catalyst is also referred to as a polymerization step.

The transparent article according to the present embodiment is obtained by molding the cyclic olefin copolymer or the resin composition containing the cyclic olefin copolymer. The cyclic olefin copolymer is obtained by the process that at least includes the preparation step and the polymerization step and satisfies the predetermined conditions. If the cyclic olefin copolymer obtained by polymerizing norbornene and ethylene contains a block polymer of ethylene as a vice-generative production in random and continuous molecule chains of norbornene and ethylene, degradation of transparency is caused. In the present embodiment, it is considered that the cyclic olefin copolymer having less generation of the above-mentioned vice-generative product and being excellent in transparency can be obtained because polymerization is performed through use of the predetermined metal-containing catalyst in the polymerization step. The structure of the cyclic olefin copolymer thus obtained is not clear. However, when the predetermined catalyst is used for polymerization, a peak of a melting point due to polyethylene-like impurities is not detected in a thermal impurity analysis using a DSC curve. Based on this fact, it is considered that generation of the above-mentioned vice-generative product is suppressed and transparency is improved.

Therefore, the transparent article according to the present embodiment is obtained by molding the cyclic olefin copolymer having less polyethylene-like impurities and being excellent in transparency or the resin composition containing the cyclic olefin copolymer, and thus is excellent in transparency. Thus, the transparent article according to the present embodiment is advantageously applicable to an article in general that requires high transparency in view of an optical function and or an aesthetic aspect. In particular, the transparent article according to the present embodiment is advantageously applicable to a general package, a shrinkable packaging film, a package for a pharmaceutical product, a package for a medical tool, a general container, a container for a pharmaceutical product, a medical device/medical tool such as a medical syringe, an examination/diagnostic tool, an optical lens, an optical film, a vehicle-mounted lens, a light-guiding plate, a lamp cover, and the like. Note that high transparency described above indicates transparency having a haze value of 0.8 or less. The haze value is measured in accordance with JIS K7136 through use of a flat-plate test piece having a size of 70 mm×70 mm×thickness of 2 mm that is formed by using the cyclic olefin copolymer or the resin composition containing the cyclic olefin copolymer that forms the transparent article according to the present embodiment, for example.

In general, when ethylene prepared at a high pressure and norbornene monomer are polymerized in the presence of a highly active catalyst, polymerization of ethylene easily progresses, and hence polyethylene-like impurities are easily generated. However, in the present embodiment, the above-mentioned metal-containing catalyst is used for polymerization of ethylene and norbornene monomer. With this, even when a pressure for preparing ethylene is high, in other words, under a condition where polyethylene-like impurities are easily generated, the cyclic olefin copolymer can easily be manufactured in a satisfactory yield while suppressing generation of polyethylene-like impurities.

Each of the steps is described below.

<Preparation Step>

In the preparation step, norbornene monomer and ethylene are prepared as monomers in the polymerization vessel. A monomer other than norbornene monomer and ethylene may be prepared in the polymerization vessel within a range where the transparent article according to the present embodiment is not disadvantageously affected. Typically, a sum of a ratio of a constituent unit derived from norbornene monomer and a ratio of a constituent unit derived from ethylene in the cyclic olefin copolymer is preferably 80% by mass or more, more preferably, 95% by mass or more, further preferably, 98% by mass or more with respect to the whole constituent units.

The monomer other than norbornene monomer and ethylene is not particularly limited as long as the monomer can be polymerized with norbornene monomer and ethylene. Typical examples of such monomer include α-olefins. The α-olefins may be substituted with at least one type of a substituent group such as a halogen atom.

As the α-olefins, C3 to C12 α-olefins are preferred. The C3 to C12 α-olefins are not particularly limited, and examples thereof include propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, and 1-dodecene. Among those, 1-hexene, 1-octene, and 1-decene are preferred.

When Condition A is satisfied, ethylene is prepared in the polymerization vessel in such a way that the pressure for preparing ethylene in the polymerization vessel is 0.5 MPa or higher.

When Condition B is satisfied, a method of preparing ethylene in a polymerization solution is not particularly limited as long as a desired amount of ethylene can be prepared in the polymerization vessel. Typically, ethylene is prepared in the polymerization vessel in such a way that the pressure for preparing ethylene in the polymerization vessel is 0.5 MPa or higher.

In any one of Conditions A and B, the pressure for preparing ethylene is preferably 0.55 MPa or higher, more preferably, 0.6 MPa or higher. When the pressure for preparing ethylene is higher, a catalyst usage amount per generated polymer can be reduced. The upper limit of the pressure for preparing ethylene is, for example, preferably 10 MPa or lower, more preferably, 5 MPa or lower, further preferably, 3 MPa or lower. Note that the preparation pressure is a gauge pressure.

A solvent may be prepared together with norbornene monomer and ethylene in the polymerization vessel. The solvent is not particularly limited as long as the solvent does not inhibit a polymerization reaction. Examples of the solvent include a hydrocarbon solvent such as pentane, hexane, heptane, octane, isooctane, isododecane, mineral oil, cyclohexane, methylcyclohexane, decahydronaphthalene (decaline), benzene, toluene, and xylene, and a halogenated hydrocarbon solvent such as chloroform, methylene chloride, dichloromethane, dichloroethane, and chlorobenzene.

When norbornene monomer is prepared in the solvent, the lower limit of the concentration of the norbornene monomer is, for example, preferably 0.5% by mass or more, more preferably, 10% by mass or more. The upper limit thereof is, for example, preferably 50% by mass or less, further preferably, 35% by mass or less.

Norbornene monomer is described below.

[Norbornene Monomer]

Examples of norbornene monomer include norbornene and substituted norbornene, and norbornene is preferred. Norbornene monomer may be used alone, or two or more kinds thereof may be used in combination.

The above-mentioned substituted norbornene is not particularly limited, examples of a substituent group of the substituted norbornene include a halogen atom, and a monovalent or a bivalent hydrocarbon group. Specific examples of the substituted norbornene include what is expressed in General Formula (I) given below.

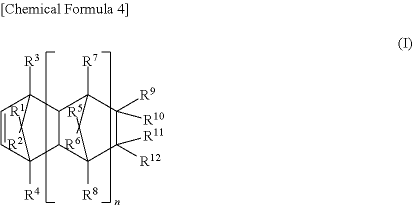

(where R¹ to R¹² are each optionally identical or different, and are selected from a group consisting of a hydrogen atom, a halogen atom, and a hydrocarbon group,

R⁹ and R¹⁰, and R¹¹ and R¹² are optionally integrated to form a bivalent hydrocarbon group,

R⁹ or R¹⁰ and R¹¹ or R¹² optionally form a ring with each other.

Further, n indicates 0 or a positive integer, and

when n is 2 or greater, R⁵ to R⁸ are each optionally identical or different in each recurring unit.

However, when n=0, at least one of R¹ to R⁴ or R⁹ to R¹² is not a hydrogen atom.)

The substituted norbornene expressed in General Formula (I) is described. R¹ to R¹² in General Formula (I) are each optionally identical or different, and are selected from a group consisting of a hydrogen atom, a halogen atom, and a hydrocarbon group.

Specific examples of R¹ to R⁸ include: a hydrogen atom; a halogen atom such as fluorine, chlorine, and bromine; and an alkyl group having 1 to 20 carbon atoms. Those are different from one another, partially different from one another, or entirely identical to one another, optionally.

Further, specific examples of R⁹ to R¹² include a hydrogen atom; a halogen atom such as fluorine, chlorine, and bromine; an alkyl group having 1 to 20 carbon atoms; a cycloalkyl group such as a cyclohexyl group; a substitutional or non-substitutional aromatic hydrocarbon group such as a phenyl group, a tolyl group, an ethylphenyl group, an isopropylphenyl group, a naphtyl group, and an anthryl group; and an aralkyl group in which a benzil group, a phenethyl group, or other alkyl groups are substituted with an aryl group. Those are different from one another, partially different from one another, or entirely identical to one another, optionally.

When R⁹ and R¹⁰ or R¹¹ and R¹² are integrated to form a bivalent hydrocarbon group, specific examples thereof include an alkylidene group such as an ethylidene group, a propylidene group, and isopropylidene group.

When R⁹ or R¹⁰ and R¹¹ or R¹² form a ring with each other, the formed ring is optionally a monocyclic ring or a polycyclic ring, a polycyclic ring having a crosslink, a ring having a double bond, or a ring formed as a combination of those rings. Further, those rings optionally include a substituent group such as a methyl group.

Specific examples of the substituted norbornene expressed in General Formula (I) include:
bicyclic olefin such as 5-methyl-bicyclo[2.2.1]hept-2-ene, 5,5-dimethyl-bicyclo[2.2.1]hept-2-ene, 5-ethyl-bicyclo[2.2.1]hept-2-ene, 5-butyl-bicyclo[2.2.1]hept-2-ene, 5-ethylidene-bicyclo[2.2.1]hept-2-ene, 5-hexyl-bicyclo[2.2.1]hept-2-ene, 5-octyl-bicyclo[2.2.1]hept-2-ene, 5-octadecyl-bicyclo[2.2.1]hept-2-ene, 5-methylidyne-bicyclo[2.2.1]hept-2-ene, 5-vinyl-bicyclo[2.2.1]hept-2-ene, and 5-propenyl-bicyclo[2.2.1]hept-2-ene;
tricyclic olefin such as tricyclo[4.3.0.1^{2,5}]deca-3,7-diene (common name: dicyclopentadiene), tricyclo[4.3.0.1^{2,5}]deca-3-ene, tricyclo[4.4.0.1^{2,5}]undeca-3,7-diene, and tricyclo[4.4.0.1^{2,5}]undeca-3,8-diene, or partially hydrogenated products thereof (or adducts of cyclopentadiene and cyclohexene) such as tricyclo[4.4.0.1^{2,5}]undeca-3-ene, 5-cyclopentyl-bicyclo[2.2.1]hept-2-ene, 5-cyclohexyl-bicyclo[2.2.1]hept-2-ene, 5-cyclohexenylbicyclo[2.2.1]hept-2-ene, 5-phenyl-bicyclo[2.2.1]hept-2-ene;
tetracyclic olefin such as tetracyclo[4.4.0.1^{2,5}.1^{7,10}]dodeca-3-ene (also simply referred to as tetracyclododecene), 8-methyltetracyclo[4.4.0.1^{2,5}.1^{7,10}]dodeca-3-ene, 8-ethyltetracyclo[4.4.0.1^{2,5}.1^{7,10}]dodeca-3-ene, 8-methylidynetetracyclo[4.4.0.1^{2,5}.1^{7,10}]dodeca-3-ene, 8-ethylidenetetracyclo[4.4.0.1^{2,5}.1^{7,10}]dodeca-3-ene, 8-vinyltetracyclo[4,4.0.1^{2,5}.1^{7,10}]dodeca-3-ene, and 8-propenyl-tetracyclo[4.4.0.1^{2,5}.1^{7,10}]dodeca-3-ene; and
polycyclic olefin such as 8-cyclopentyl-tetracyclo[4.4.0.1^{2,5}.1^{7,10}]dodeca-3-ene, 8-cyclohexyl-tetracyclo[4.4.0.1^{2,5}.1^{7,10}]dodeca-3-ene, 8-cyclohexenyl-tetracyclo[4.4.0.1^{2,5}.1^{7,10}]dodeca-3-ene, 8-phenyl-cyclopentyl-tetracyclo[4.4.0.1^{2,5}.1^{7,10}]dodeca-3-ene, tetracyclo[7.4.1^{3,6}.0^{1,9}.0^{2,7}]tetradeca-4,9,11,13-tetraene (also referred to as 1,4-methano-1,4,4a,9a-tetrahydrofluorene), tetracyclo[8.4.1^{4,7}.0^{1,10}.0^{3,8}]pentadeca-5,10,12,14-tetraene (also referred to as 1,4-methano-1,4,4a,5,10,10a-hexahydroanthracene), pentacyclo[6.6.1.1^{3,6}.0^{2,7}.0^{9,14}]-4-hexadecene, pentacyclo[6.5.1.1^{3,6}.0^{2,7}.0^{9,13}]-4-pentadecene, pentacyclo[7.4.0.0^{2,7}.1^{3,6}.1^{10,13}]-4-pentadecene, heptcyclo[8.7.0.1^{2,9}.1^{4,7}.1^{11,17}.0^{3,8}.0^{12,16}]-5-eicosen, heptcyclo[8.7.0.1^{2,9}.0^{3,8}.1^{4,7}.0^{12,17}.1^{13,16}]-14-eicosen, and a tetramer of cyclopentadiene.

Among those, an alkyl substituted norbornene (for example, bicyclo[2.2.1]hept-2-ene substituted with one or more alkyl groups) and an alkylidene substituted norbornene (for example, bicyclo[2.2.1]hept-2-ene substituted with one or more alkylidene groups) are preferred, and 5-ethylidene-bicyclo[2.2.1]hept-2-ene (common name: 5-ethylidene-2-norbornene, or simply ethylidenenorbornene) is more preferred.

<Polymerization Step>

In the polymerization step, the monomers in the polymerization vessel are polymerized in the presence of the predetermined metal-containing catalyst.

A temperature at the time of polymerization is not particularly limited. In view of a satisfactory yield of the cyclic olefin copolymer, the temperature at the time of polymerization is preferably 20° C. or higher, more preferably, 30° C. or higher, further preferably, 50° C. or higher, further more preferably, 60° C. or higher, particularly preferably, 70° C. or higher. The temperature at the time of polymerization may be 80° C. or higher, and may be 85° C. or higher.

The upper limit of the temperature at the time of polymerization is not particularly limited. The upper limit of the temperature at the time of polymerization may be, for example, 200° C. or lower, 140° C. or lower, or 120° C. or lower.

[Metal-Containing Catalyst]

In a case of Condition A, as the metal-containing catalyst to be used for polymerization, there is used a metal-containing catalyst having a ligand including a cyclopentadiene ring and a structure in which and a hetero atom being N, O, S, or P are bonded to transition metal of the fourth group in the periodic table and sp² carbon. Further, in a case of Condition B, as the metal-containing catalyst, there is used a metal-containing catalyst having a structure in which a nitrogen atom is bonded to transition metal of the fourth group in the periodic table and an atom of the fifteenth group in the periodic table. In any one of the conditions, such a catalyst is used, and thus the cyclic olefin copolymer can be manufactured in a satisfactory yield while suppressing generation of polyethylene-like impurities. Note that, in the present specification, the sp² carbon indicates a carbon atom forming an sp² hybrid orbital.

In any one of Conditions A and B, in the metal-containing catalyst, as the transition metal of the fourth group in the periodic table, Ti, Zr, or Hf are preferred, and Ti is more preferred. Further, in Condition B, in the metal-containing catalyst, as the atom of the fifteenth group in the periodic table, P, As, and Sb are preferred, and P is more preferred.

In Condition A, in the metal-containing catalyst, a substituent group is optionally bonded to the hetero atom and the sp² carbon that are described above, and the substituent group that is bonded to the hetero atom and the sp² carbon is not particularly limited within a range where the effects of the transparent article according to the present embodiment are not inhibited.

In Condition B, the metal-containing catalyst preferably includes a ligand coordinated as the transition metal of the fourth group in the periodic table. As the ligand, in view of high activeness of the metal-containing catalyst, a ligand including a cyclopentadiene ring is preferred.

In Condition A, or in a case in which the metal-containing catalyst

contains the ligand including a cyclopentadiene ring in Condition B, preferred examples of the ligand including a cyclopentadiene ring include cyclopentadiene, methylcyclopentadiene, dimethylcyclopentadiene, trimethylcyclopentadiene, tetramethylcyclopentadiene, pentamethylcyclopentadiene, n-butylcyclopentadiene, di-n-butylcyclopentadiene, tert-butylcyclopentadiene, di-tert-butylcyclopentadiene, adamantylcyclopentadiene, monomethylindene, dimethylindene, trimethylindene, tetramethylindene, 4,5,6,7-tetrahydroindene, fluorene, 5,10-dihydroindeno[1,2-b]indole, N-methyl-5,10-dihydroindeno[1,2-b]indole, N-phenyl-5,10-dihydroindeno[1,2-b]indole, 5,6-dihydroindeno[2,1-b]indole, N-methyl-5,6-dihydroindeno[2,1-b]indole, and N-phenyl-5,6-dihydroindeno[2,1-b]indole.

The metal-containing catalyst as described above contains a metal-containing compound expressed in Formula (a1) given below. Note that the meta-containing compound expressed in Formula (a1) given below incudes the metal-containing catalyst used in Condition A and the metal-containing catalyst used in Condition B.

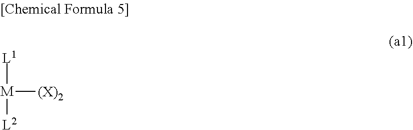

In Formula (a1), M is Ti, Zr, or Hf, and Ti is particularly preferred in view of availability and easiness of manufacturing of the metal-containing catalyst, activity of the catalyst, and the like. X is an organic substituent group having 1 to 20 carbon atoms and optionally containing a hetero atom, or a halogen atom.

L¹ is a group expressed in Formula (a1a) or Formula (a1b) given below. When L¹ is a group expressed in Formula (a1a) given below, L² is a group expressed in Formula (a1b), Formula (a1c), or Formula (a1d) given below. Further, when L¹ is a group expressed in Formula (a1b) given below, L² is a group expressed in Formula (a1b) given below, in other words, both L¹ and L² are groups expressed in Formula (b1b). Further, in this case, L¹ and L² are optionally identical groups or different groups, and are preferably identical groups.

Here, when L¹ is a group expressed in Formula (a1a), and L² is a group expressed in Formula (a1c) or Formula (a1d), the metal-containing compound expressed in Formula (a1) corresponds to a metal-containing compound having a structure in which the ligand including a cyclopentadiene ring and the hetero atom being N, O, S, or P are bonded to the transition metal of the fourth group in the periodic table and the sp² carbon.

Further, when L¹ is a group expressed in Formula (a1a), and L² is a group expressed in Formula (a1b), the metal-containing compound expressed in

Formula (a1) corresponds to a metal-containing compound having a structure in which the nitrogen atom is bonded to the transition metal of the fourth group in the periodic table and the atom of the fifteenth group in the periodic table.

Moreover, when both L¹ and L² are groups expressed in Formula (a1b), the metal-containing compound expressed in Formula (a1) corresponds to a metal-containing compound having a structure in which the nitrogen atom is bonded to the transition metal of the fourth group in the periodic table and the atom of the fifteenth group in the periodic table.

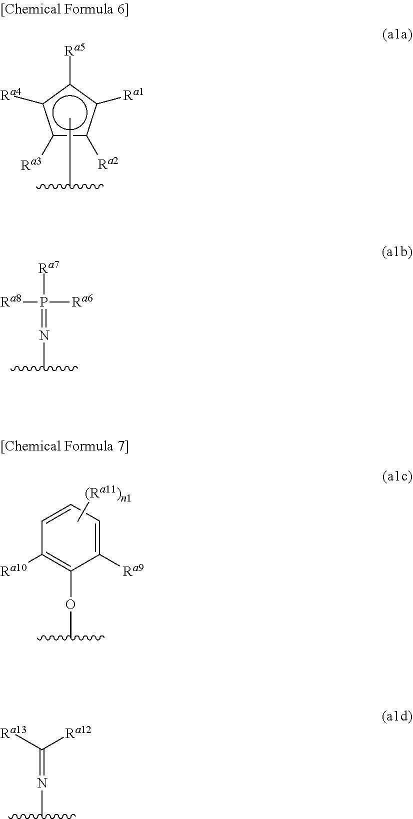

In Formula (a1a), R^{a1} to R^{a5} are each independently identical or different optionally, and each individually a hydrogen atom, an organic substituent group having 1 to 20 carbon atoms and optionally containing a hetero atom, or an inorganic substituent group. Two groups among R^{a1} to R^{a5} that are adjacent to each other on a five-membered ring are mutually bonded and form a ring optionally.

In Formula (a1b), R^{a6} to R^{a8} are each independently identical or different optionally, and each individually a hydrogen atom, an organic substituent group having 1 to 20 carbon atoms and optionally containing a hetero atom, or an inorganic substituent group. Two groups selected from R^{a6} to R^{a8} are mutually bonded and form a ring optionally.

In Formula (a1), X is an organic substituent group having 1 to 20 carbon atoms and optionally containing a hetero atom or a halogen atom.

With regard to the organic substituent group having 1 to 20 carbon atoms and optionally containing a hetero atom, when the organic substituent group includes the hetero atom, a kind of the hetero atom is not particularly limited. Specific examples of the hetero atom include an oxygen atom, a nitrogen atom, a sulfur atom, a phosphorus atom, a silicon atom, a selenium atom, and a halogen atom.

The organic substituent group is not particularly limited as long as the organic substituent group does not inhibit a generation reaction of the metal-containing compound expressed in Formula (a1) given above. Examples thereof include an alkyl group having 1 to 20 carbon atoms, an alkoxy group having 1 to 20 carbon atoms, a cycloalkyl group having 3 to 20 carbon atoms, a fatty acyl group having 2 to 20 carbon atoms, a benzoyl group, an α-naphtylcarbonyl group, a β-naphtylcarbonyl group, an aromatic hydrocarbon group having 6 to 20 carbon atoms, an aralkyl group having 7 to 20 carbon atoms, a trialkylsilyl group having 3 to 20 carbon atoms, a mono-substituted amino group substituted with a hydrocarbon group having 1 to 20 carbon atoms, and a di-substituted amino group substituted with a hydrocarbon group having 1 to 20 carbon atoms.

Among those organic substituent groups, an alkyl group having 1 to 6 carbon atoms, an alkoxy group having 1 to 6 carbon atoms, a cycloalkyl group having 3 to 8 carbon atoms, a fatty acyl group having 2 to 6 carbon atoms, a benzoyl group, a phenyl group, a benzil group, a phenethyl group, and a trialkylsilyl group having 3 to 10 carbon atoms are more preferred.

Among those organic substituent groups, a methyl group, an ethyl group, an n-propyl group, an isopropyl group, an n-butyl group, an isobutyl group, a sec-butyl group, a tert-butyl group, a methoxy group, an ethoxy group, an n-propyloxy group, an isopropyloxy group, an n-butyloxy group, an isobutyloxy group, a sec-butyloxy group, a tert-butyloxy group, an acetyl group, a propionyl group, a butanoyl group, a phenyl group, a trimethylsilyl group, and a tert-butyldimethylsilyl group are more preferred.

As X, a halogen atom is preferred, a chlorine atom and a bromine atom are more preferred, and a chlorine atom is particularly preferred.

In Formula (a1a), R^{a1} to R^{a5} are each independently identical or different optionally, and each individually a hydrogen atom, an organic substituent group having 1 to 20 carbon atoms and optionally containing a hetero atom, or an inorganic substituent group. Further, two groups among R^{a1} to R^{a5} that are adjacent to each other on a five-membered ring are mutually bonded and form a ring optionally.

Specific examples and preferred examples of the organic substituent group having 1 to 20 carbon atoms and optionally containing a hetero atom as R^{a1} to R^{a5} are respectively similar to the specific examples and the preferred examples of the organic substituent group having 1 to 20 carbon atoms and optionally containing a hetero atom as X.

The inorganic substituent group is not particularly limited as long as the inorganic substituent group does not inhibit a generation reaction of the metal-containing compound expressed in Formula (a1) given above.

Specific examples of the inorganic substituent group include a halogen atom, a nitro group, a non-substituted amino group, and a cyano group.

In Formula (a1b), R^{a6} to R^{a8} are each independently identical or different optionally, and each individually a hydrogen atom, an organic substituent group having 1 to 20 carbon atoms and optionally containing a hetero atom, or an inorganic substituent group. Further, two groups selected from R^{a6} to R^{a8} are mutually bonded and form a ring optionally.

Specific examples and preferred examples of the organic substituent group having 1 to 20 carbon atoms and optionally containing a hetero atom as R^{a6} to R^{a8} are respectively similar to the specific examples and the preferred examples of the organic substituent group having 1 to 20 carbon atoms and optionally containing a hetero atom as X.

In addition, as R^{a6} to R^{a8}, the organic substituent group having 1 to 20 carbon atoms and optionally containing a hetero atom is preferably a group expressed in Formula (a1b), and is also preferably such a group that R^{a6} to R^{a8} are each independently a hydrocarbon group having 1 to 20 carbon atoms.

When the organic substituent group having 1 to 20 carbon atoms and optionally containing a hetero atom is a group expressed in Formula (a1b), preferred examples of R^{a6} to R^{a8} include —N═P(Me)₃, —N═P(Et)₃, —N═P(n-Pr)₃, —N═P(iso-Pr)₃, —N═P(n-Bu)₃, —N═P(iso-Bu)₃, —N═P(sec-Bu)₃, —N═P(tert-Bu)₃, and —N═P(Ph)₃. Among those, —N═P(tert-Bu)₃ and —N═P(iso-Pr)₃ are preferred, and N═P(tert-Bu)₃ is more preferred. Note that Me indicates a methyl group, Et indicates an ethyl group, n-Pr indicates an n-propyl group, iso-Pr indicates an iso-propyl group, n-Bu indicates an n-butyl group, iso-Bu indicates an isobutyl group, sec-Bu indicates a sec-butyl group, tert-Bu indicates a tert-butyl group, and Ph indicates a phenyl group.

Further, specific examples of the inorganic substituent group as R^{a6} to R^{a8} are similar to the specific examples of the inorganic substituent group as R^{a1} to R^{a5}.

Preferred examples of the group expressed in Formula (a1b) include —N═P(Me)₃, —N═P(Et)₃, —N═P(n-Pr)₃, —N═P(iso-Pr)₃, —N═P(n-Bu)₃, —N═P(iso-Bu)₃, —N═P(sec-Bu)₃, —N═P(tert-Bu)₃, —N═P(Ph)₃, —N═P(—N═P(tert-Bu)₃)Ph₂, and —N═P(—N═P(iso-Pr)₃)Ph₂. Among those, —N═P(tert-Bu)₃ and —N═P(iso-Pr)₃ are preferred, and —N═P(tert-Bu)₃ is more preferred.

In Formula (a1c), R^{a9} to R^{a11} are each independently identical or different optionally, and are each independently a hydrogen atom, an organic substituent group having 1 to 20 carbon atoms and optionally containing a hetero atom, or an inorganic substituent group, and n1 is an integer from 0 to 3. n1 is an integer from 0 to 3, preferably, 0 or 1, more preferably, 0.

Specific examples and preferred examples of the above-mentioned group with regard to R^{a9} to R^{a11} in Formula (a1c) are similar to the specific examples and the preferred examples of the above-mentioned group with regard to R^{a1} to R^{a5}.

The preferred examples of the group expressed in Formula (a1c) include a phenoxy group, a 2,6-dimethylphenoxy group, and a 2,6-diisopropylphenoxy group.

In Formula (a1d), R^{a12} and R^{a13} are each independently identical or different optionally, and each individually a hydrogen atom, an organic substituent group having 1 to 20 carbon atoms and optionally containing a hetero atom, or an inorganic substituent group. The two groups including R^{a12} and R^{a13} are mutually bonded and form a ring optionally.

Specific examples and preferred examples of the organic substituent group having 1 to 20 carbon atoms and optionally containing a hetero atom as R^{a12} and R^{a13} are respectively similar to the specific examples and the preferred examples of the organic substituent group having 1 to 20 carbon atoms and optionally containing a hetero atom as X.

Further, a mono-substituted amino group substituted with a hydrocarbon group having 1 to 20 carbon atoms and a di-substituted amino group substituted with a hydrocarbon group having 1 to 20 carbon atoms are both preferred as the organic substituent group.

With regard to the mono-substituted amino group or the di-substituted amino group as R^{a12} and R^{a13} in Formula (a1d), preferred examples of the hydrocarbon group having 1 to 20 carbon atoms that is bonded to a nitrogen atom include a hydrocarbon group included in the preferred examples of the organic substituent group as X.

Specific examples of the inorganic substituent group as R^{a12} and R^{a13} are similar to the specific examples of the inorganic substituent group as R^{a1} to R^{a5}.

Preferred examples of the group expressed in Formula (a1d) includes the following groups.

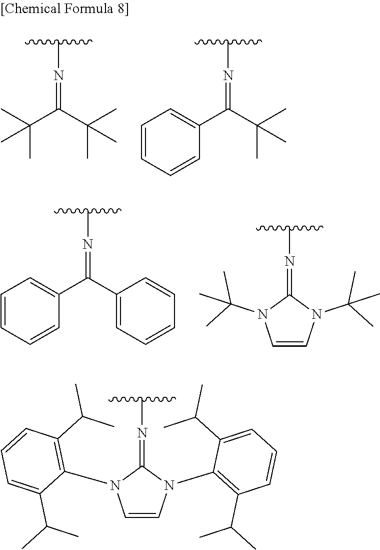

Among the metal-containing compounds expressed in Formula (a1) described above, preferred specific examples corresponding to Condition A include metal-containing compounds (A-1) to (A-30) given below. Among those, in view of availability and easiness of manufacturing of the metal-containing catalyst, activity of the catalyst, and the like, the metal-containing compounds with a cyclopentadiene ring having a substituent group are more preferred. Among the metal-containing compounds with a cyclopentadiene ring having a substituent group, the metal-containing compounds (A-3) to (A-9), (A-12), (A-15), (A-18) to (A-24), (A-27), and (A-30) given below are more preferred, the metal-containing compounds (A-3), (A-7) to (A-9), (A-12), (A-15), (A-18), (A-22) to (A-24), (A-27), and (A-30) given below are further preferred, and the metal-containing compounds (A-7) to (A-8), (A-12), (A-15), (A-22) to (A-23), (A-27), and (A-30) given below are most preferred. Note that M in the formula given below is similar to M in Formula (a1). Further, in the formula given below, n-Bu indicates an n-butyl group, tert-Bu indicates a tert-butyl group, Si(Me)₃ indicates a trimethylsilyl group, and Si(Me)₂tert-butyl indicates a tert-butyldimethylsilyl group.

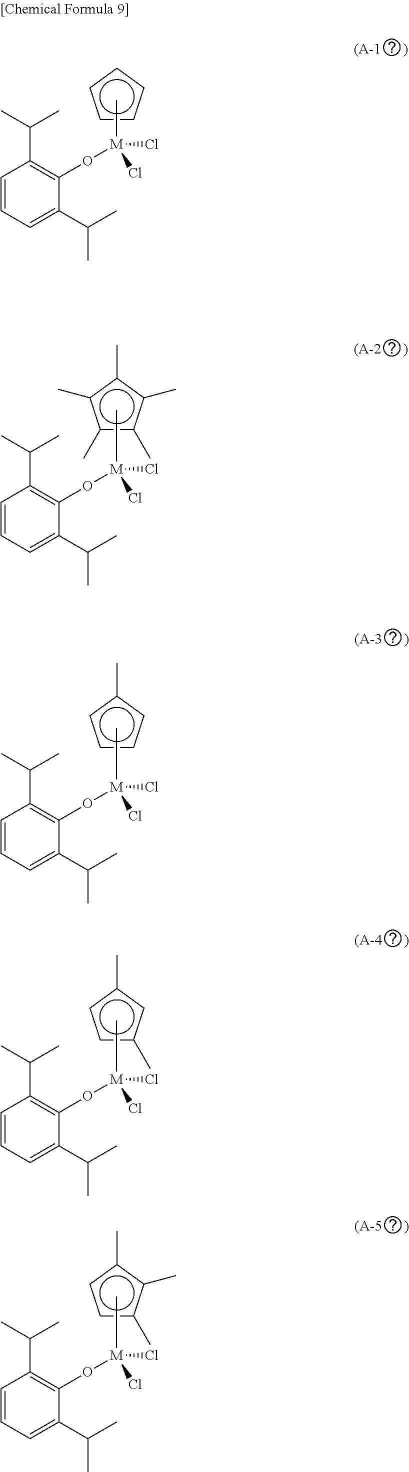

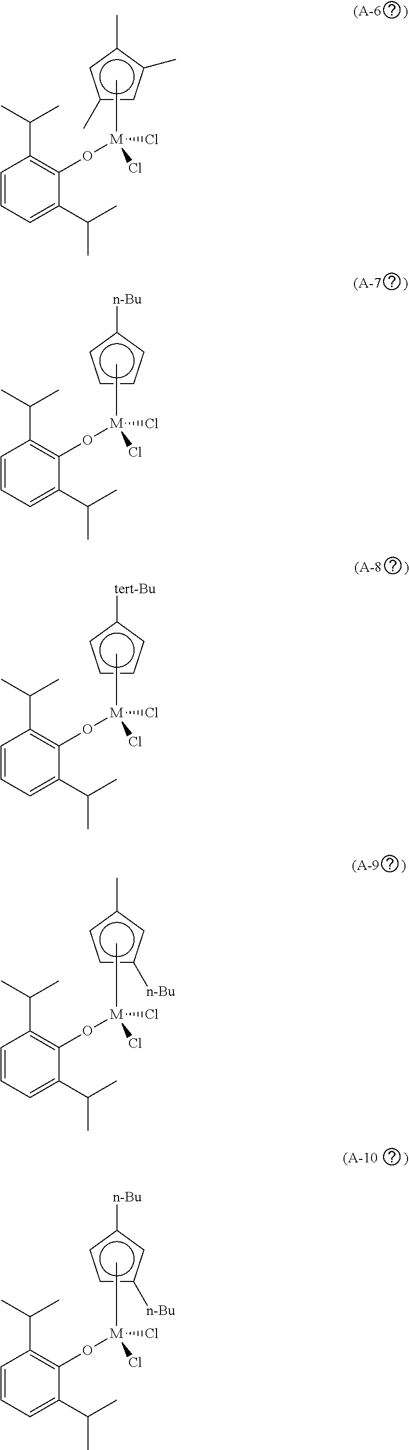

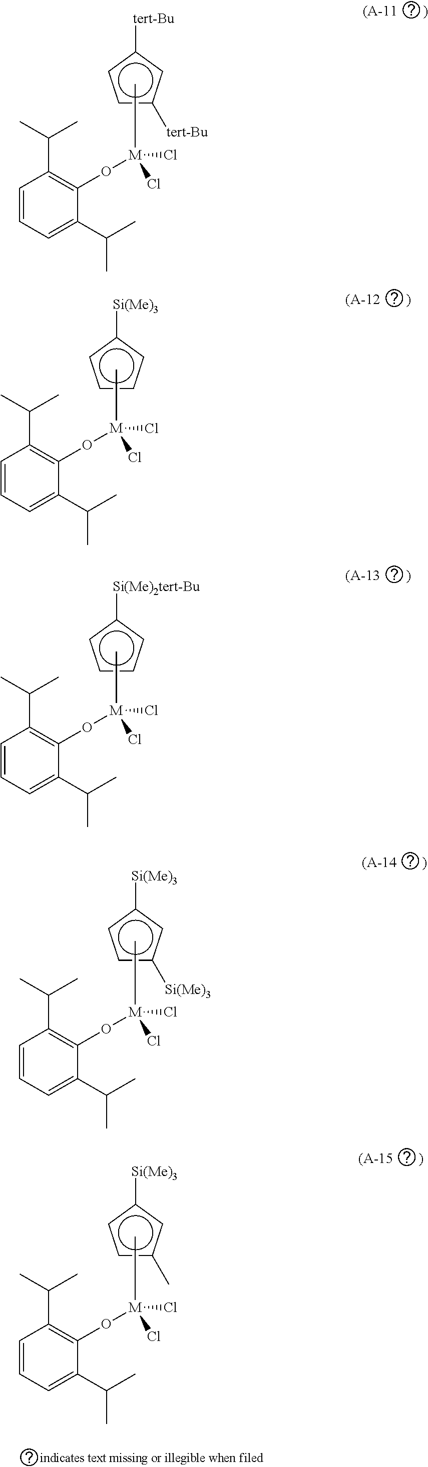

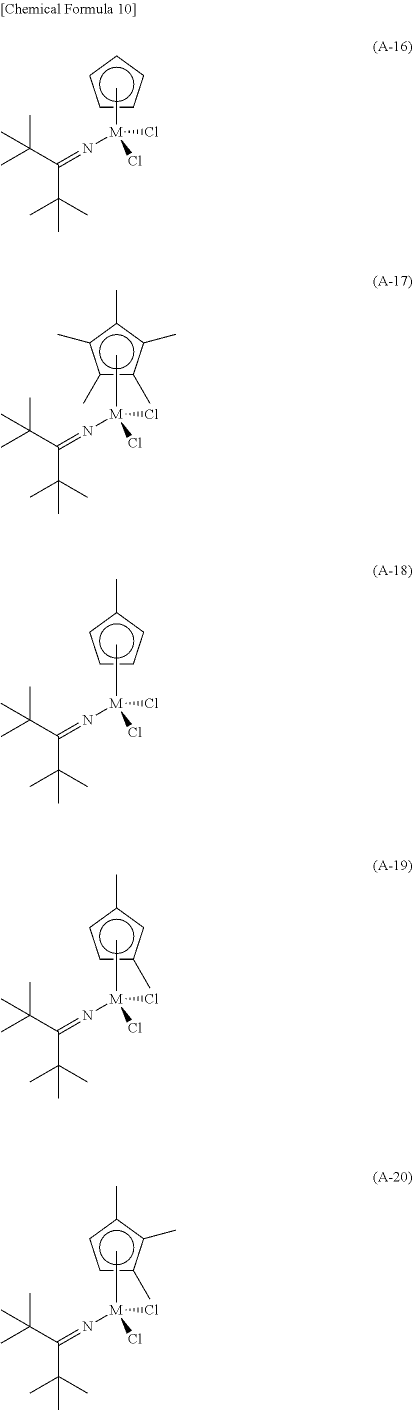

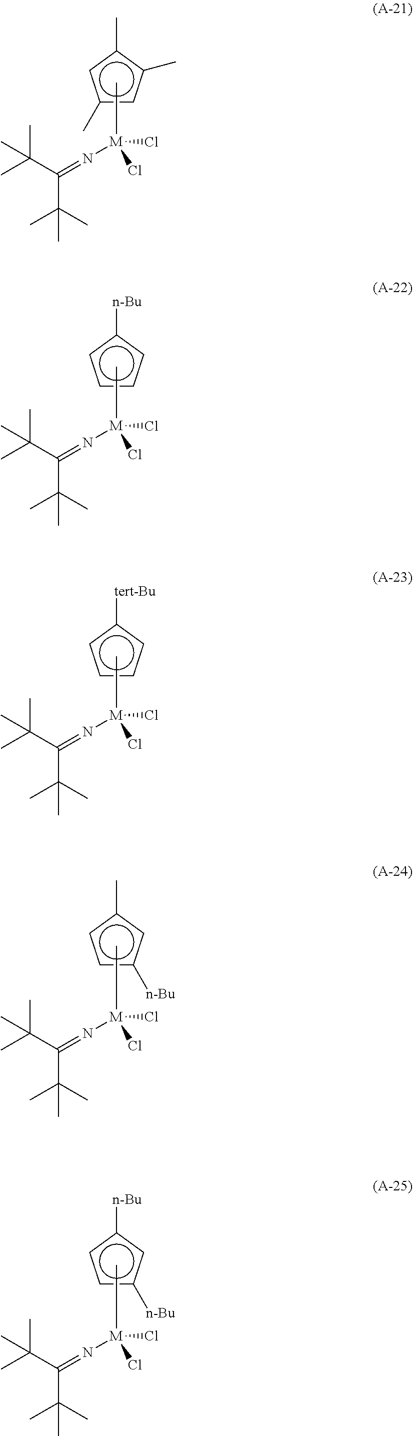

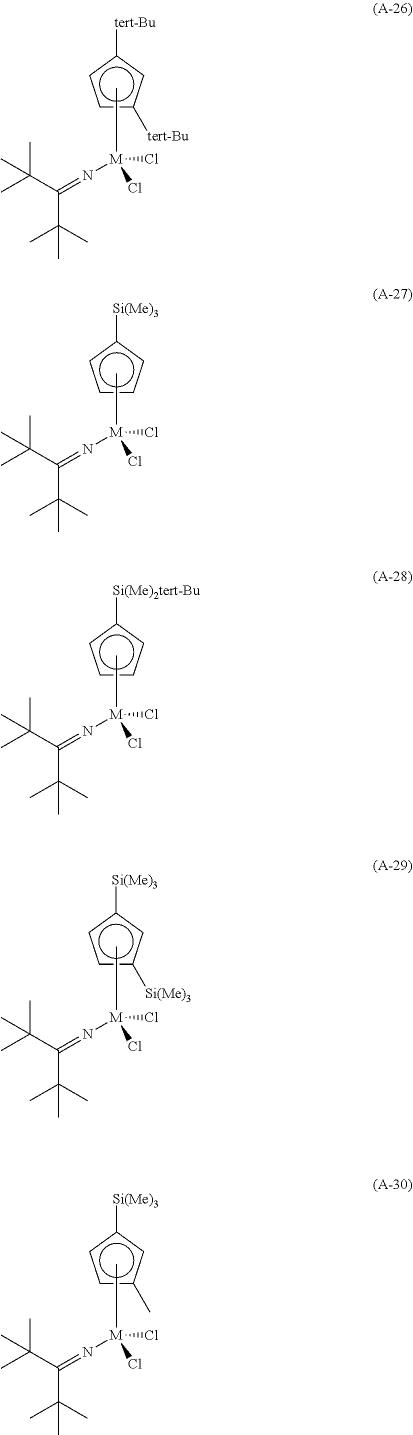

Further, among the metal-containing compounds expressed in Formula (a1) described above, preferred specific examples corresponding to Condition B include the following metal-containing compounds ((B-1) to (B-39)). When the metal-containing catalyst has a cyclopentadiene ring, the metal-containing compounds (B-1), (B-3), (B-7) to (B-8), (B-12), (B-16), (B-18), (B-22) to (B-23), and (B-27) given below are particularly preferred among those, in view of availability and easiness of manufacturing of the metal-containing catalyst, activity of the catalyst, and the like. Note that M in the formula given below is similar to M in Formula (a1). Further, in the formula given below, Me indicates a methyl group, Et indicates an ethyl group, n-Pr indicates an n-propyl group, iso-Pr indicates an iso-propyl group, n-Bu indicates an n-butyl group, iso-Bu indicates an isobutyl group, sec-Bu indicates a sec-butyl group, tert-Bu indicates a tert-butyl group, Ph indicates a phenyl group, Si(Me)₃ indicates a trimethylsilyl group, and Si(Me)₂tert-butyl indicates a tert-butyldimethylsilyl group.

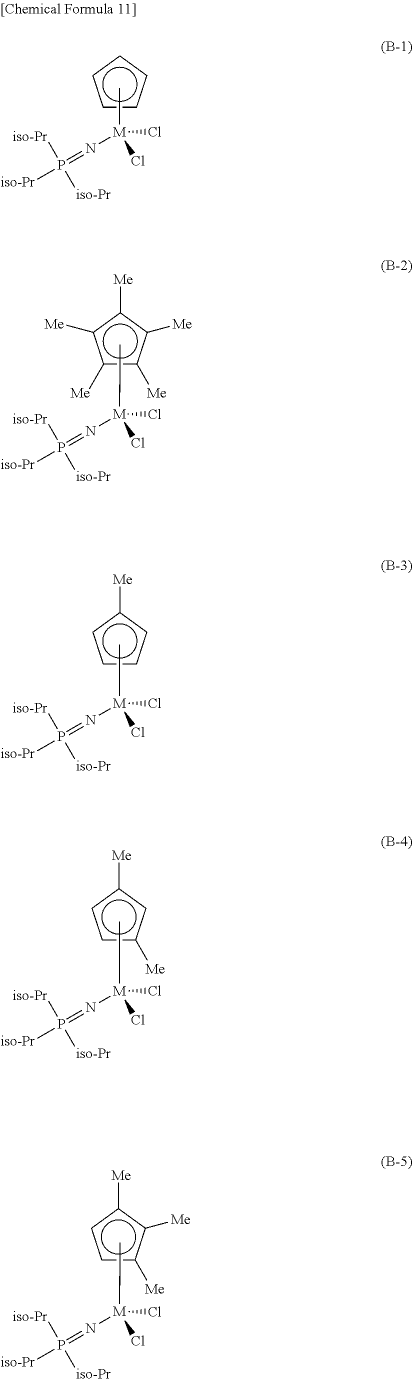

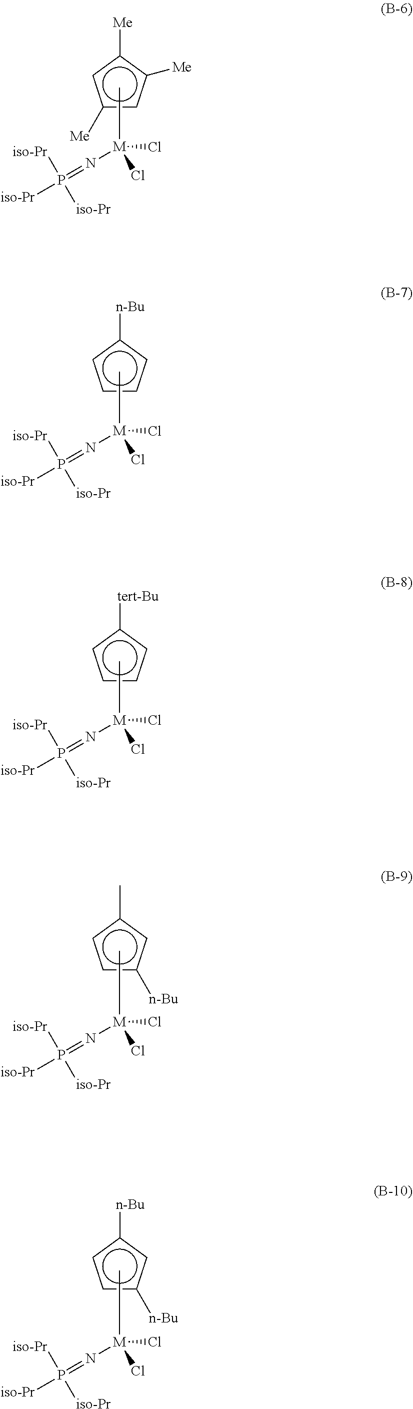

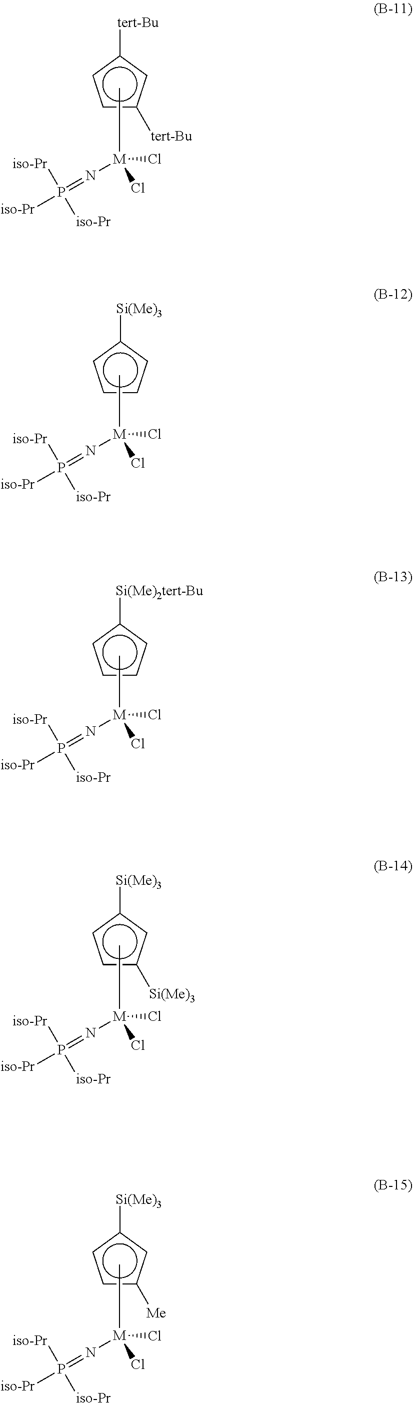

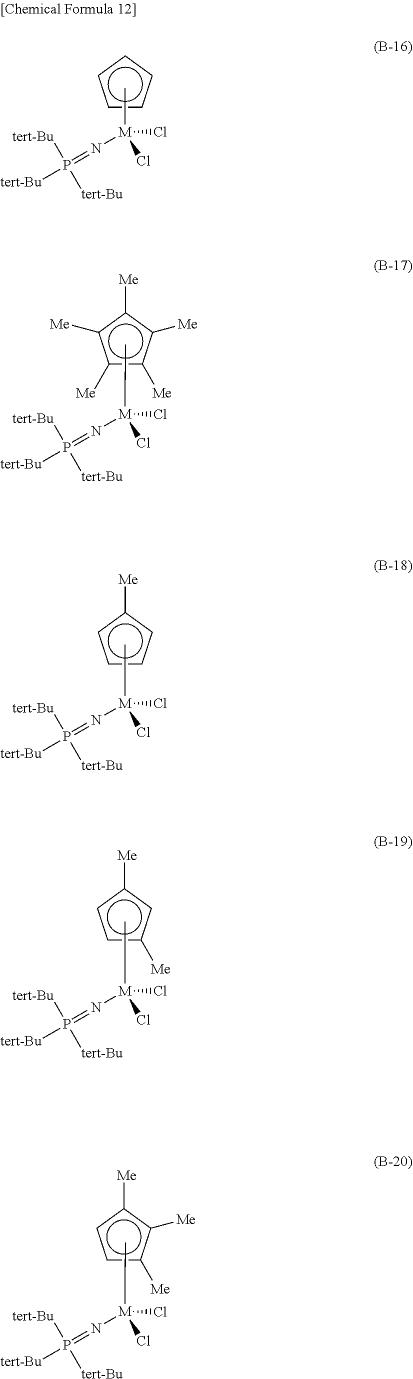

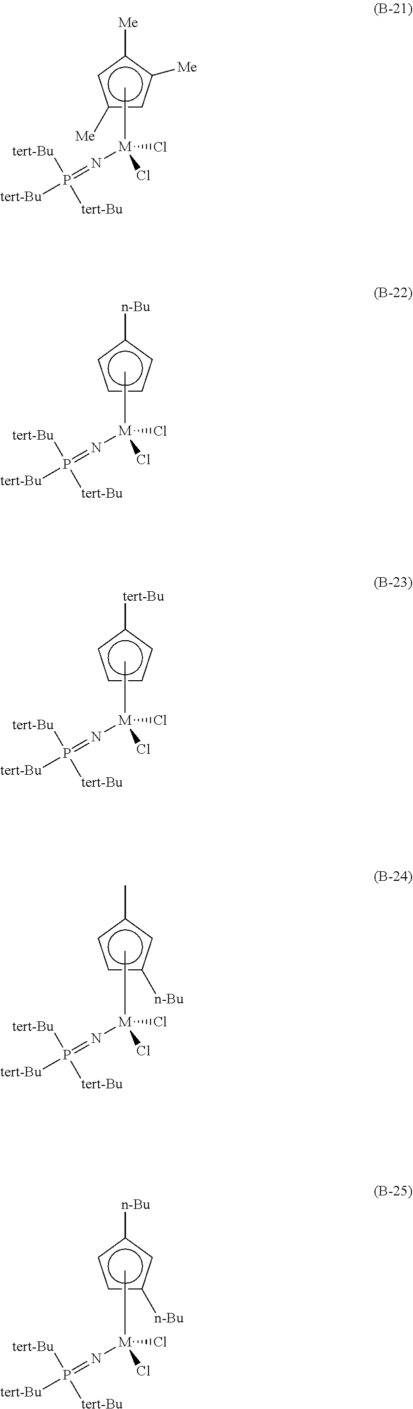

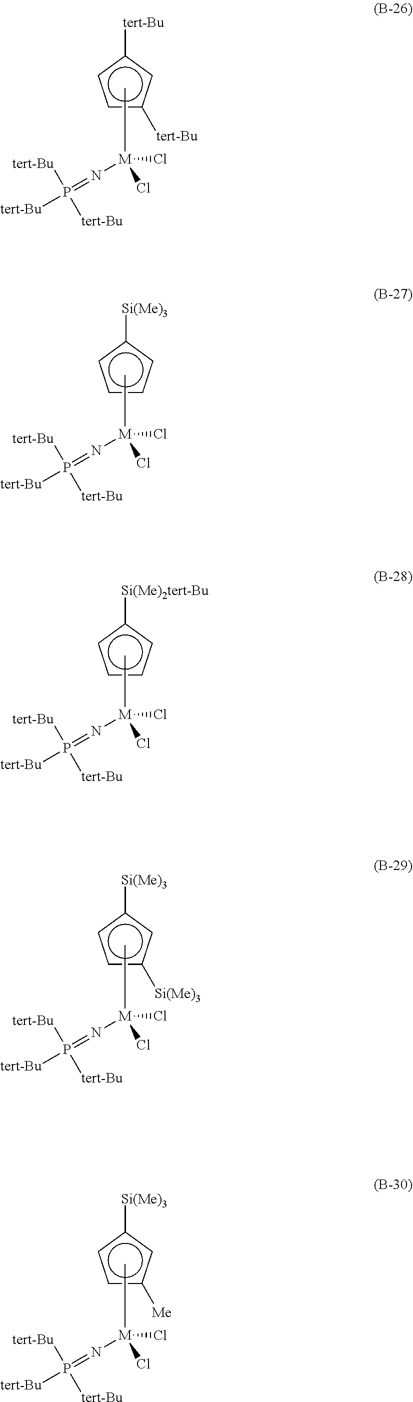

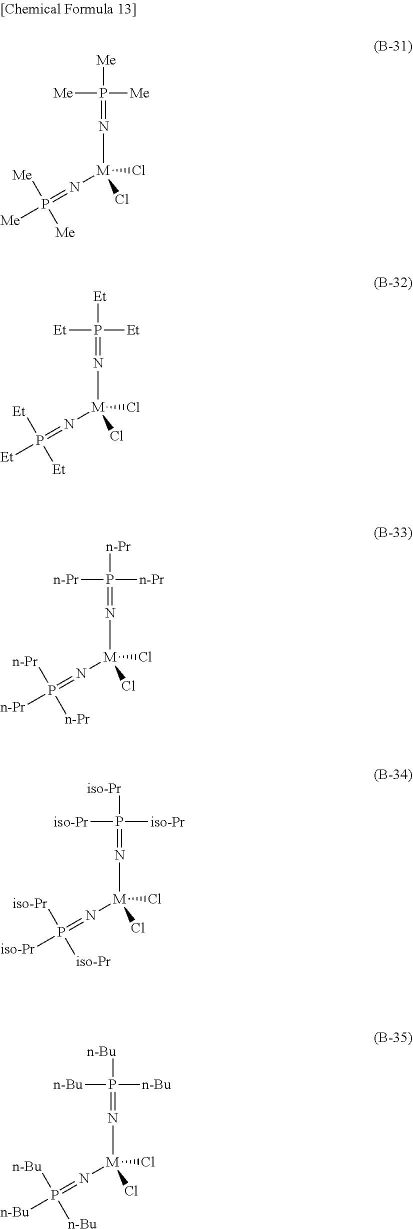

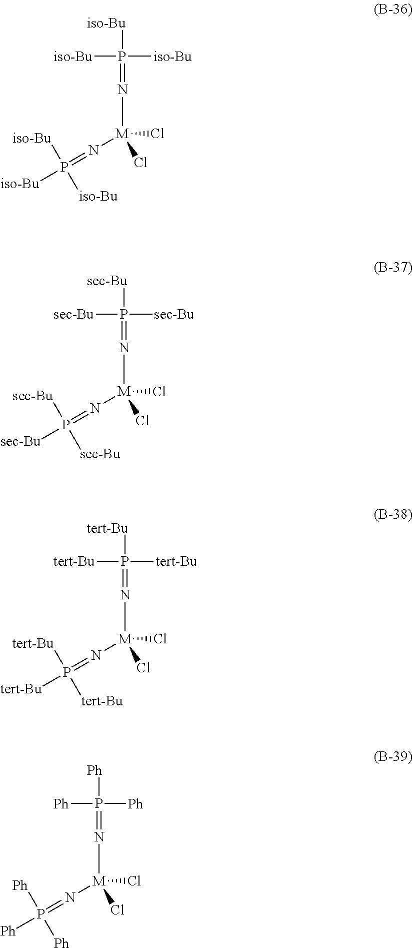

The monomers are preferably polymerized in the presence of the above-mentioned metal-containing catalyst and a co-catalyst. As the co-catalyst, a compound that is generally used as a co-catalyst for polymerization of olefin may be used without any particular limitations. Preferred examples of the co-catalyst include aluminoxane and an ionic compound. In view of satisfactory progress in a polymerization reaction, at least one of aluminoxane or a borate compound being an ionic compound is particularly preferably used as the co-catalyst for polymerization of the monomers.

The metal-containing catalyst is preferably a catalyst composition obtained through mixing with aluminoxane and/or the ionic compound.

Here, the ionic compound is a compound that generates a cationic transition metal compound by a reaction with the metal-containing catalyst.

The catalyst composition is preferably prepared through use of a solution of the metal-containing catalyst. The solvent contained in the solution of the metal-containing catalyst is not particularly limited. Examples of the preferred solvent include a hydrocarbon solvent such as pentane, hexane, heptane, octane, isooctane, isododecane, mineral oil, cyclohexane, methylcyclohexane, decahydronaphthalene (decaline), benzene, toluene, and xylene, and a halogenated hydrocarbon solvent such as chloroform, methylene chloride, dichloromethane, dichloroethane, and chlorobenzene.

A use amount of the solvent is not particularly limited as long as the

catalyst composition having a desired function can be produced. Typically, the solvent is used by such an amount that the concentration of the metal-containing catalyst, aluminoxane, and the ionic compound is preferably 0.00000001 to 100 mol/L, more preferably, 0.00000005 to 50 mol/L, particularly preferably 0.0000001 to 20 mol/L.

At the time of mixing of a solution containing raw materials for the catalyst composition, Mₐ indicates the number of mols of the transition metal element in the metal-containing catalyst, M_{b1} indicates the number of mols of aluminum in aluminoxane, and M_{b2} indicates the number of mols of the ionic compound. In this case, the solution containing the raw materials for the catalyst composition is preferably mixed in such a way that a value of (M_{b1}+M_{b2})/Mₐ is preferably 1 to 200000, more preferably, 5 to 100000, particularly preferably, 10 to 80000.

The temperature at which the solution containing the raw materials for the catalyst composition is not particularly limited, and is preferably from −100 to 100° C., more preferably, from −50 to 50° C.

Mixing of the solution of the metal-containing catalyst with aluminoxane and/or the ionic compound for preparation of the catalyst composition may be performed in a device different from the polymerization vessel before polymerization, or may be performed in the polymerization vessel before polymerization or in the middle of polymerization.

Description is made below on the materials used for preparation of the catalyst composition and the preparation conditions of the catalyst composition.

[Aluminoxane]

As aluminoxane, various types of aluminoxane that have hitherto been used as a co-catalyst for polymerization of various types of olefin may be used without any particular limitations. Typically, aluminoxane is organic aluminoxane. At the time of producing the catalyst composition, one type of aluminoxane may be used along, or two or more kinds thereof may be used in combination.

As aluminoxane, alkylaluminoxane is preferably used. Examples of alkylaluminoxane include a compound expressed in Formula (b1-1) or (b1-2) given below. Alkylaluminoxane expressed in Formula (b1-1) or (b1-2) given below is a product obtained by a reaction between trialkylaluminum and water.

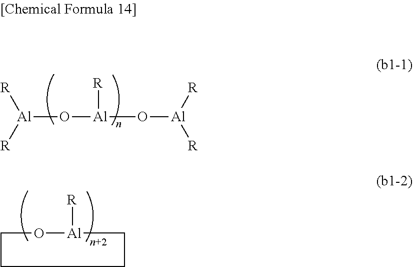

(where, in Formula (b1-1) and Formula (b1-2), R is an alkyl group having 1 to 4 carbon atoms, and n is an integer from 0 to 40, preferably, from 2 to 30.)

Examples of alkylaluminoxane include modified methylaluminoxane obtained by substituting a part of a methyl group of methylaluminoxane and methylaluminoxane with another alkyl group. As modified methylaluminoxane, for example, modified methylaluminoxane having, as an alkyl group after substitution, an alkyl group having 2 to 4 carbon atoms, such as an ethyl group, a propyl group, an isopropyl group, a butyl group, and an isobutyl group, is preferred, and modified methylaluminoxane obtained by substituting a part of a methyl group with an isobutyl group is more preferred. Specific examples of alkylaluminoxane include methylaluminoxane, ethylaluminoxane, propylaluminoxane, butylaluminoxane, isobutylaluminoxane, methylethylaluminoxane, methylbutylaluminoxane, and methylisobutylaluminoxane. Among those, methylaluminoxane and methylisobutylaluminoxane are preferred.

Alkylaluminoxane may be prepared by a publicly known method. Further, a commercial product may be used as alkylaluminoxane. Examples of the commercial product of alkylaluminoxane include MMAO-3A, TMAO-200 series, TMAO-340 series, and solid MAO (all of which are produced by Tosoh Finechem Corporation), and a methylaluminoxane solution (produced by Albemarle Corporation). In view of easy suppression of generation of polyethylene-like impurities, alkylaluminoxane other than solid MAO is used more preferably.

[Ionic Compound]

The ionic compound is a compound that generates a cationic transition metal compound by a reaction with the metal-containing catalyst.

As the ionic compound described above, an ionic compound containing an ion exemplified by, for example, an anion of tetrakis(pentafluorophenyl)borate, an amine cation having an active proton such as a dimethylphenylammonium cation ((CH₃)₂N(C₆H₅)H⁺), a tri-substituted carbonium cation such as (C₆H₅)₃C⁺, a carborane cation, a metal carborane cation, and a ferrocenium cation having transition metal.

Preferred examples of the ionic compound include borate. Preferred specific examples of borate include tetrakis(pentafluorophenyl)tritylborate, dimethylphenylammoniumtetrakis(pentafluorophenyl)borate, and N-methyldialkylammoniumtetrakis(pentafluorophenyl)borate such as N,N-dimethylaniliniumtetrakis(pentafluorophenyl)borate and N-methyl di-n-decyl ammoniumtetrakis(pentafluorophenyl)borate.

Further, in view of casy manufacturing of the cyclic olefin copolymer in a satisfactory yield, in Condition A, one or more kinds that are selected from aluminoxane, an alkylaluminium compound, an aromatic compound having, on an aromatic ring, one or a plurality of phenolic hydroxyl groups and one or a plurality of halogen atoms, and hindered phenol are preferably present in the polymerization vessel before adding the metal-containing catalyst or the catalyst composition containing the metal-containing catalyst. Similarly, in Condition B, one or more kinds that are selected from aluminoxane and an alkylaluminium compound are preferably present. In the above-mentioned aromatic compound having a phenolic hydroxyl group and a halogen atom, the phenolic hydroxyl group and the halogen atom are bonded on the same aromatic ring that is optionally a monocyclic ring or a condensed ring.

Hindered phenol indicates phenols having a bulky substituent group at at least one of two adjacent positions of the phenolic hydroxyl group. Examples of the bulky substituent group include an alkyl group other than a methyl group, such as an isopropyl group, an isobutyl group, a sec-butyl group, and a tert-butyl group, an alkenyl group, an alkynyl group, an aryl group, a heterocyclic group, an alkoxy group, an aryloxy group, a substituted amino group, an alkylthio group, and an arylthiol.

Specific examples of hindered phenol include 2,6-di-tert-butyl-p-cresol(BHT), 2,6-di-tert-butylphenol, 2-tert-butylphenol, 2-tert-butyl-p-cresol, 3,3′,5,5′-tetra-tert-butyl-4,4′-dihydroxybiphenyl, 3,3′,5,5′-tetra-tert-butyl-2,2′-dihydroxybiphenyl, 4,4′-butylidenebis(3-methyl-6-tert-butylphenol), 2,2′-methylenebis(6-tert-butyl-4-methylphenol), 4,4′,4″-(1-methylpropanyl-3-ylidene)tris(6-tert-butyl-m-cresol), and 1,3,5-tris(3,5-di-tert-butyl-4-hydroxyphenylmethyl)2,4,6-trimethylbenzene. Among those, 2,6-di-tert-butyl-p-cresol(BHT) and 2,6-di-tert-butylphenol are preferred because a molecular weight thereof is small and desired effects exerted by use of hindered phenol can easily be obtained even in a small amount of use.

Hindered phenol reacts with the alkylaluminium compound in the polymerization system, and thus contributes to an increase of the yield of the cyclic olefin copolymer. Thus, hindered phenol is preferably used together with alkylaluminum. Further, hindered phenol may be mixed with alkylaluminum in the polymerization machine and used. The mixture obtained by mixing alkylaluminum and hindered phenol before polymerization may be introduced into the polymerization machine.

Aluminoxane is as described above with reference to the method of manufacturing the catalyst composition.

As the alkylaluminium compound, the compounds that have hitherto been used for polymerization of olefins and the like may be used without any particular limitations. Examples of the alkylaluminium compound include a compound expressed in General Formula (II) given below.

(R¹⁰)₂AlX_{3-z} (II)
(where, in Formula (II), R¹⁰ is an alkyl group having 1 to 15 carbon atoms, preferably, 1 to 8 carbon atoms, X is a halogen atom or a hydrogen atom, and z is an integer from 1 to 3.)

Examples of the alkyl group having 1 to 15 carbon atoms include a methyl group, an ethyl group, an n-propyl group, an isopropyl group, an n-butyl group, an isobutyl group, and an n-octyl group.

Specific examples of the alkylaluminium compound include: trialkylaluminum such as trimethylaluminum, triethylaluminum, triisopropylaluminum, tri-n-butylaluminum, triisobutylaluminum, trisec-butylaluminum, tri-n-octylaluminum; dialkylaluminumhalide such as dimethylaluminumchloride, diisobutylaluminumchloride; dialkylaluminumhydride such as diisobutylaluminumhydride; and dialkylaluminumalkoxide such as dimethylaluminummethoxide.

The alkylaluminium compound described above acts as a chain transfer agent, and promotes chain polymerization catalyzed by the above-mentioned catalyst composition. As the chain transfer agent, hydrogen is also used preferably in place of the alkylaluminium compound.

When aluminoxane is added in the polymerization vessel before the metal-containing catalyst or the catalyst composition containing the metal-containing catalyst is added, a use amount of aluminoxane is set in such a way that the number of mols of aluminum in aluminoxane with respect to 1 mol of the transition metal compound is preferably 1 to 1000000 mol, more preferably, 10 to 100000 mol.

When the alkylaluminium compound is added in the polymerization vessel before the metal-containing catalyst or the catalyst composition containing the metal-containing catalyst is added, a use amount of the alkylaluminium compound is set in such a way that the number of mols of aluminum with respect to I mol of the transition metal compound is preferably 1 to 500,000 mol, more preferably, 10 to 50,000 mol.

In Condition A, polymerization is preferably performed in the presence of the metal-containing catalyst, aluminoxane, and hindered phenol or in the presence of the metal-containing catalyst, the ionic compound, and alkylaluminum. When polymerization is performed in the presence of the metal-containing catalyst, the ionic compound, and alkylaluminum, hindered phenol is also preferably present in the polymerization system.

The polymerization conditions are not particularly limited as long as the conditions enable acquisition of the cyclic olefin copolymer having desired properties, and publicly known conditions may be used.

The use amount of the catalyst is derived from the use amount of the transition metal compound used for the preparation. The use amount of the catalyst composition is set in such a way that a mass of the transition metal compound used for the preparation is preferably 0.000000001 to 0.005 mol, more preferably, 0.00000001 to 0.0005 mol with respect to 1 mol of norbornene monomer.

The polymerization time period is not particularly limited, and polymerization is performed until a desired yield is achieved or a molecular weight of the polymer is increased to a desired degree.

The polymerization time period differs depending on a temperature, a catalyst composition, and a monomer composition, and is typically from 0.01 hours to 120 hours, preferably, from 0.1 hours to 80 hours, more preferably, from 0.2 hours to 10 hours.

It is preferred that at least a part, preferably, an entirety of the catalyst composition be continuously added in the polymerization vessel.

When the catalyst composition is continuously added, the cyclic olefin copolymer can continuously be manufactured, which reduces a manufacturing cost of the cyclic olefin copolymer.

According to the method described above, the monomers containing norbornene monomer and ethylene are copolymerized, and thus the cyclic olefin copolymer can efficiently be manufactured while suppressing generation of polyethylene-like impurities.

The glass transition temperature of the cyclic olefin copolymer thus obtained is not particularly limited, and is preferably 185° C. or lower, more preferably, 160° C. or lower, further preferably, 130° C. or lower, further more preferably, 120° C. or lower, particularly preferably, 100° C. or lower, for example, in view of processability.

Further, a sample of the cyclic olefin copolymer that is manufactured by the above-mentioned method is measured by a differential scanning calorimeter (DSC) under a nitrogen atmosphere and at a temperature rising rate of 20° C./min in accordance with the method described in JIS K7121. In this case, it is preferred that the DSC curved thus obtained do not have a peak of a melting point (melting enthalpy) derived from polyethylene-like impurities. This indicates that polyethylene-like impurities are not present or extremely small in the cyclic olefin copolymer. Note that, when polyethylene-like impurities are contained in the cyclic olefin copolymer, the peak of the melting point derived from polyethylene-like impurities on the DSC curve is generally detected within a range from 100° C. to 140° C.

In the transparent article according to the present embodiment, the cyclic olefin copolymer described above is excellent in transparency, and hence it is most preferred that the transparent article be formed only by the cyclic olefin copolymer. However, other resin components may be contained as a resin component in addition to the cyclic olefin copolymer as long as transparency is not degraded. The other resin components are not particularly limited, and examples thereof include other cyclic olefin copolymers, an olefin resin, and a thermoplastic elastomer. Further, two or more kinds of a resin component may be used.

Meanwhile, in the present embodiment, the cyclic olefin copolymer is preferably a resin composition containing a cyclic olefin copolymer in which an antioxidant is further contained. In other words, the transparent article according to the present embodiment is preferably obtained through molding by further adding an antioxidant to the cyclic olefin copolymer or the resin composition. By adding the antioxidant, decomposition/degradation or yellowing of the resin composition at the time of processing can be suppressed. The antioxidant may be used alone, or two or more kinds thereof may be used in combination. Examples of the antioxidant include a hindered phenol-based antioxidant and a phenol-based oxidant. Further, a hindered amine-based antioxidant or an antioxidant such as a sulfur compound may be used in combination. Specifically, examples of the hindered phenol-based antioxidant include 2,6-di-tert-butyl-p-cresol, stearyl-(3,5-dimethyl-4-hydroxybenzil)thioglycolate, stearyl-β-(4-hydroxy-3,5-di-tert-butylphenyl)propionate, distearyl-3,5-di-tert-butyl-4-hydroxybenzilphosphonate, distearyl(4-hydroxy-3-methyl-5-tert-butyl)benzilmalonate, 2,2′-methylenebis(4-methyl-6-tert-butylphenol), 4,4′-methylenebis(2,6-di-tert-butylphenol), 2,2′-methylenebis[6-(1-methylcyclohexyl)-p-cresol], bis[3,3-bis(4-hydroxy-3-tert-butylphenyl)butylic acid]glycol ester, 4,4′-butylidenebis(6-tert-butyl-m-cresol), 1,1,3-tris(2-methyl-4-hydroxy-5-t-butylphenyl)butane, 1,3,5-tris(3,5-di-tert-butyl-4-hydroxybenzil)-2,4,6-trimethylbenzene, tetrakis[methylene-3-(3,5-di-tert-butyl-4-hydroxyphenyl)propionate]methane, 1,3,5-tris(3,5-di-t-butyl-4-hydroxybenzil)isocyanurate, 1,3,5-tris[(3,5-di-tert-butyl-4-hydroxyphenyl)propionyloxyethyl]isocyanurate, 2-octylthio-4,6-di(4-hydroxy-3,5-di-tert-butyl)phenoxy-1,3,5-triazine, 4,4′-thiobis(6-tert-butyl-m-cresol), triethyleneglycol-bis[3-(3-tert-butyl-5-methyl-4-hydroxyphenyl)propionate], 1,6-hexyldiol-bis[3-(3,5-di-tert-butyl-4-hydroxyphenyl)propionate], 2,4-bis-octylthio-6-(4-hydroxy-3,5-di-tert-butylanilino)-1,3,5-triazine, 2,2-thio-diethylenebis[3-(3,5-di-tert-butyl-4-hydroxyphenyl)propionate], N,N-hexamethylenebis(3,5-di-tert-butyl-4-hydroxy-hydrocinnamamide), 3,5-di-tert-butyl-4-hydroxy-benzilphosphonate-diethylester, 1,3,5-trimethyl-2,4,6-tris(3,5-di-tert-butyl-4-hydroxybenzil)benzene, tris-(3,5-di-tert-butyl-4-hydroxybenzil)isocyanurate, isooctyl-3-(3,5-di-tert-butyl-4-hydroxyphenyl)propionate, and 2,4-bis[(octylthio)methyl]-o-cresol.

In the present embodiment, in the resin composition, the antioxidant is contained preferably in an amount of 0.01 to 5% by mass, more preferably, in an amount of 0.1 to 1% by mass.

In the present embodiment, within a range where the effects thereof are not inhibited, publicly known additives, which are generally added to a thermoplastic resin and a thermosetting resin so as to provide desired properties in accordance with a purpose thereof, may be blended in the resin composition in addition to the respective components described above. In other words, a mold releasing agent, a lubricant, a plasticizing agent, a flame retardant, a coloring agent such as dyes and pigments, a crystallization accelerator, a nucleating agent, a thermal stabilizer, a weatherproof stabilizer, a corrosion inhibitor, and the like may be blended.

### EXAMPLES

The present embodiment is further specifically described below with reference to Examples, and the present embodiment is not limited to Examples given below.

### Example 1

157 kg of decaline and 23 kg of norbornene were added into a polymerization machine produced by SUS that had a 1 cubic-meter capacity in which nitrogen substitution was sufficiently performed under a nitrogen atmosphere, and then 0.59 kg of a co-catalyst 1 (triisobutylaluminum (produced by Tosoh Finechem Corporation)/a toluene solution (1 mol/L)) were fed.

Subsequently, ethylene was caused to flow through the polymerization machine for saturation. The polymerization machine was heated to 90° C., and was pressurized to a gauge pressure of 0.9 MPa. After confirmation of sufficient stabilization of the temperature in the polymerization machine, 0.53 g of a catalyst 1 (toluene solution) was added. Further, 3 g of a co-catalyst 2 (N-methyl dialkylammoniumtetrakis(pentafluorophenyl)borate (alkyl: C14 to C18 (average: C17.5)) (produced by Tosoh Finechem Corporation)) were added. Then, after a 15-miniute reaction, 2-propanol was added to the polymerization solution to stop the polymerization. The structure of the catalyst 1 used herein was as described below.

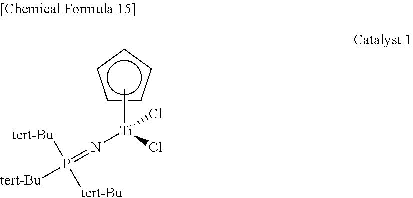

The polymer solution thus obtained as described above was transferred to a polymerization machine that had a two cubic-meter capacity and was subjected to glass lining. The metal components contained in the polymer solution were removed through use of hydrochloric acid in a molar amount of approximately 10 times as much as all the metal amounts, and then the polymer solution was dropped in acetone. With this, a cyclic olefin copolymer was deposited. The polymer thus obtained was filtered, was cleansed with sufficient acetone, and then was vacuum-dried at 50° C.for 24 hours. Finally, the cyclic olefin copolymer was obtained.

The copolymer yield (kg) per 1 g of the catalyst, which was calculated from the use amount of the catalyst and the acquisition amount of the copolymer, is shown in Table 1.

### Example 2, Comparative Example 1

The cyclic olefin copolymer was obtained similarly to Example 1 except that the amount of norbornene, the catalysts and the amounts thereof, the co-catalysts and the amounts thereof, and the amount of the solution were changed as shown in Table 1. Note that a co-catalyst 3 was a MMAO-3A toluene solution in an amount of 6.5% by mass (in a content amount of Al atoms) (a solution of methylisobutylaluminoxane expressed by [(CH₃)_{0.7}(iso-C₄H₉)_{0.3}AlO]ₙ, produced by Tosoh Finechem Corporation: Note that trimethylaluminum was contained in an amount of 6 mol % with respect to entire Al.). Further, a co-catalyst 4 was a TMAO-211 toluene solution in an amount of 9.0% by mass (in a content amount of Al atoms) (a methylaluminoxane solution, produced by Tosoh Finechem Corporation: Note that trimethylaluminum was contained in an amount of 26 mol % with respect to entire Al.). Further, the structures used in the catalysts 2 and 3 used in Example 2 and Comparative Example 1 were as described below.

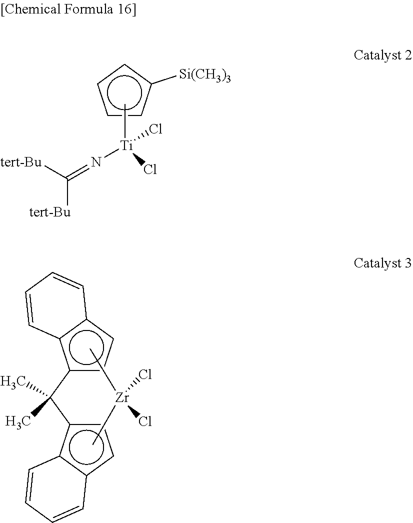

<Evaluation>

The cyclic olefin copolymer thus obtained in each of the examples and the comparative example were used for the following evaluations.

(1) Glass Transition Temperature (Tg) of Cyclic Olefin Copolymer

Through use of a DSC device (a differential scanning calorimeter, DSC-Q1000 produced by TA Instruments), a glass transition temperature (Tg) was measured under a nitrogen atmosphere and at a temperature rising rate of 10° C./min in accordance with the DSC method (the method described in JIS K7121). The measurement results are shown in Table 1.

(2) Thermal Impurity Analysis

A heat generation amount (mJ/mg) was calculated based on a peak area of a melting point derived from polyethylene-like impurities, which was observed within arrange from 100° C. to 140° C. on the DSC curve obtained at the time of measuring the glass transition temperature. The calculation results are shown in Table 1. As the calculated heat generation amount was larger, the content amount of polyethylene-like impurities was larger.

Note that N.D. in Table 1 indicates that, on the DSC curve, a peak of a melting point derived from polyethylene-like impurities was not detected.

(3) Evaluation on Transparency (Yellowness Index, Haze Value)

The cyclic olefin copolymer thus obtained in each of the examples and the comparative example were used to produce a test piece in the following manner.

The cyclic olefin copolymer to which an antioxidant (tetrakis[methylene3(3,5di-t-butyl-4-hydroxyphenyl)propionate]methane, Irganox1010 produced by BASF Japan Ltd.) was added in an amount of 0.1% by mass was fed into a twin-screw extruder (product name:TEX30, produced by The Japan Steel Works, Ltd.) having a cylinder temperature of 220° C., was melted and mixed, and then was formed into pellets. Through use of the resin composition pellets thus obtained, a flat plate having a size of 70 mm×70 mm×thickness of 2 mm was molded at a cylinder temperature of 220° C., a mold temperature of 50° C., at an injection speed of 80 mm/sec in an injection molding machine (product name:SE75D, produced by Sumitomo Heavy Industries, Ltd.). In this manner, a test piece was obtained. The test piece thus obtained was used for the following evaluations.

(3-1) Yellowness Index (YI)

A yellowness index (DIN 6167) of each of the test pieces was measured through use of a color-difference meter (color-sphere produced by BYK-Gardner GmbH).

(3-2) Haze Value

A haze value of each of the test pieces was measured by the method in accordance with JIS K7136 through use of a haze meter (Haze-Gard II produced by Toyo Seiki Seisaku-sho, Ltd.).

When the haze value was 0.8 or less, evaluation as excellent transparency was given.

TABLE 1

| | | | Example 1 | Example 2 | Comparative Example 1 |
|---|---|---|---|---|---|
| Norbornene | | kg | 23 | 15 | 22 |
| Solvent (decaline) | | kg | 157 | 163 | 156 |
| Catalyst 1 | | g | 0.53 | — | — |
| Catalyst 2 | | g | — | 0.53 | — |
| Catalyst 3 | | g | — | — | 2.0 |
| Co-catalyst 1 | | kg | 0.59 | — | — |
| Co-catalyst 2 | | kg | 3 | — | — |
| Co-catalyst 3 | | kg | — | 1.0 | — |
| Co-catalyst 4 | | g | — | — | 2.5 |
| Yield per 1 g of catalyst | | kg | 15 | 12 | 7 |
| Glass transition temperature (Tg) | | ° C. | 87 | 88 | 82 |
| Thermal impurity analysis | | mJ/mg | N.D. | N.D. | 0.9 |
| Transparency | Yellowness index | — | 0.56 | 0.59 | 0.89 |
| | Haze value | — | 0.43 | 0.60 | 0.97 |

From Table 1, it is understood that the test pieces in Examples 1 and 2 had a smaller yellowness index and a smaller Haze value and were excellent in transparency as compared to that in Comparative Example 1. In other words, it is considered that generation of polyethylene-like impurities was suppressed and transparency was improved because the cyclic olefin copolymers in Examples 1 and 2 were obtained by polymerization with the specific catalysts. Therefore, the transparent article according to the present embodiment obtained by molding the cyclic olefin copolymer or the resin composition containing the cyclic olefin copolymer as described above has a small yellowness index and a small Haze value, and is excellent in transparency.

1. A transparent article obtained by molding a cyclic olefin copolymer containing a constituent unit derived from a norbornene monomer and a constituent unit derived from ethylene or a resin composition containing the cyclic olefin copolymer, wherein
the cyclic olefin copolymer is obtained by a process that at least includes a step of preparing a norbornene monomer and ethylene as monomers in a polymerization vessel and a step of polymerizing the monomers in the polymerization vessel in presence of a metal-containing catalyst and satisfies Condition A and Condition B given below.
Condition A: a pressure for preparing ethylene in the polymerization vessel is 0.5 MPa or higher, and the metal-containing catalyst has a ligand including a cyclopentadiene ring and a structure in which a hetero atom being N, O, S, or P are bonded to transition metal of the fourth group in the periodic table and sp² carbon.
Condition B: the metal-containing catalyst has a structure in which a nitrogen atom is bonded to transition metal of the fourth group in periodic table and an atom of the fifteenth group in periodic table.

2. The transparent article according to claim 1, wherein
the atom of the fifteenth group in the periodic table is a phosphorus atom.

3. The transparent article according to claim 1, wherein
the metal-containing catalyst is a metal-containing compound expressed in Formular (a1) given below: 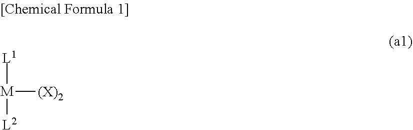
where, in Formula (a1), M is Ti, Zr, or Hf, X is an organic substituent group having 1 to 20 carbon atoms and optionally containing a hetero atom, or a halogen atom, and L¹ is a group expressed in Formula (a1a) or Formula (a1b) given below; 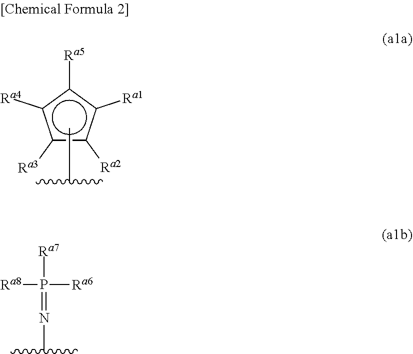
where, when L¹ is a group expressed in Formula (a1a) given above, L² is a group expressed in Formula (a1b), Formula (a1c), or Formula (a1d) given below; 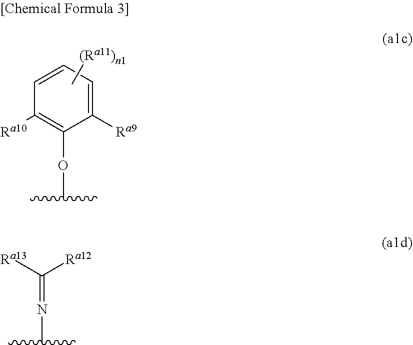
where, when L¹ is a group expressed in Formula (a1b) given above, L² is a group expressed in Formula (a1b) given above;
where, in Formula (a1a), R^{a1} to R^{a5} are each independently identical or different optionally, and are each independently a hydrogen atom, an organic substituent group having 1 to 20 carbon atoms and optionally containing a hetero atom, or an inorganic substituent group, and two groups among R^{a1} to R^{a5} that are adjacent to each other on a five-membered ring are mutually bonded and form a ring optionally;
where, in Formula (a1b), R^{a6} to R^{a8} are each independently identical or different optionally, and are each independently a hydrogen atom, an organic substituent group having 1 to 20 carbon atoms and optionally containing a hetero atom, or an inorganic substituent group, and two groups selected from R^{a6} to R^{a8} are mutually bonded and form a ring optionally;
where, in Formula (a1c), R^{a9} to R^{a11} are each independently identical or different optionally, and are each independently a hydrogen atom, an organic substituent group having 1 to 20 carbon atoms and optionally containing a hetero atom, or an inorganic substituent group, and n1 is an integer from 0 to 3; and
where, in Formula (a1d), R^{a12} and R^{a13} are each independently identical or different optionally, and are each independently a hydrogen atom, an organic substituent group having 1 to 20 carbon atoms and optionally containing a hetero atom, or an inorganic substituent group, and the two groups including R^{a12} and R^{a13} are mutually bonded and form a ring optionally.

4. The transparent article according to claim 1, wherein
the transition metal of the fourth group in the periodic table is Ti.

5. The transparent article according to claim 1, wherein
the monomers in the polymerization vessel are polymerized at a temperature of 85° C. or higher.

6. The transparent article according to claim 1, wherein
the cyclic olefin copolymer has a glass transition temperature of 185° C. or lower.

7. The transparent article according to claim 1, wherein
a DSC curve does not have a peak of a melting point derived from polyethylene-like impurities within a range from 100° C. to 140° C., the DSC curve being obtained by measuring a sample of the cyclic olefin copolymer by a differential scanning calorimeter under a nitrogen atmosphere and at a temperature rising rate of 20° C./min in accordance with a method described in JIS K7121.

8. The transparent article according to claim 1, wherein
the monomers are polymerized in the presence of the metal-containing catalyst and a co-catalyst.

9. The transparent article according to claim 8, wherein
the co-catalyst contains at least one of aluminoxane or a borate compound.

10. The transparent article according to claim 1, wherein
the monomers are polymerized in presence of a hydrocarbon solvent.

11. The transparent article according to claim 1, wherein
the transparent article is obtained by further adding an antioxidant to the cyclic olefin copolymer or the resin composition.
